(19) United States
(12) Patent Application Publication
(10) Pub. No.: US 2023/0402864 A1
(43) Pub. Date: Dec. 14, 2023

(54) CELL BATTERY FAST CHARGING METHOD AND SYSTEM

(71) Applicant: Yazami IP PTE.LTD., Singapore (SG)

(72) Inventor: Rachid Yazami, Singapore (SG)

(21) Appl. No.: 18/250,606

(22) PCT Filed: Oct. 26, 2021
(86) PCT No.: PCT/IB2021/059887

§ 371 Date: Apr. 26, 2023

(30) Foreign Application Priority Data
Oct. 26, 2020 (SG) 10202010561W

(51) Int. Cl. H02J 7/00; H01M 10/44

(52) U.S. Cl. CPC H02J 7/0069; H02J 7/0048; H01M 10/441; H01M 10/446

(57) ABSTRACT

A method for fast charging a battery cell provided with charge/discharge terminals to which a charging voltage can be applied with a flowing charging current, the method comprising the steps of: applying to terminals of the battery cell a plurality of constant voltage stages Vⱼ, where Vⱼ₊₁>Vⱼ, j=1, 2 . . . , k, each voltage stage comprising intermittent nⱼ voltage plateaus, between two successive voltage plateaus within a voltage stage, letting the charging current going to rest for a rest period, Rⱼ^{p}, 1≤p≤nⱼ, the fast-charging method proceeding until either one of the following conditions is reached: a pre-set charge capacity or state of charge is reached, the cell temperature exceeds a pre-set limit value Tₗᵢₘ and the cell voltage has exceeded a pre-set limit value Vₗᵢₘ.

### CROSS-REFERENCE TO RELATED APPLICATIONS

This application is a national phase entry under 35 U.S.C. § 371 of International Patent Application PCT/IB2021/059887, filed Oct. 26, 2021, designating the United States of America and published as International Patent Publication WO 2022/090932 A1 on May 5, 2022, which claims the benefit under Article 8 of the Patent Cooperation Treaty to Singapore Patent Application Serial No. 10202010561W, filed Oct. 26, 2020.

### TECHNICAL FIELD

The present disclosure relates to a method for fast charging a battery cell and to a fast-charging system implementing such method.

### BACKGROUND

As compared to other rechargeable batteries operating at the ambient temperatures such alkaline-electrolyte and acid-electrolyte based batteries, lithium-ion batteries (LIB) show the best combined performances in terms of energy density (E_{d}), power density (P_{d}), life span, operation temperature range, lack of memory effect, lower and lower costs and recyclability.

The LIB market is expanding exponentially to cover the three main applications: a) mobile electronics (ME) (cellphones, handhold devices, laptop PCs . . . ), b) electromobility (EM) (e-bikes, e-cars, e-buses, drones, aerospace, boats, . . . ), and c) stationary energy storage systems (ESS) (power plants, buildings/houses, clean energy (solar, wind, . . . ), industry, telecom . . . .

The fastest growing market segment of LIB is the electromobility market.

In electromobility, energy density goes with the operation time and driving range of any electric vehicle (EV). Higher E_{d} provides longer driving range when using a battery pack of a fixed weight (kg) and volume (l).

The energy density of LIB has been steadily improved since their commercialization. However, recent years showed a slowdown in E_{d} increase with a plateau around 250 Wh/kg and 700 Wh/l at the cell level.

Because of E_{d} and P_{d} limitations current EV, which are mostly LIB powered, have a driving range of about 250 km to 650 km per full charge and a full charging time above 60 min.

Current internal combustion cars can fill a tank in 5-10 min and provide a driving range up to 900 km.

To ensure success public acceptance of EV for the coming energy transition the most serious option today is fast charging. Current fast charging stations for EV provide a limited amount of charge below 60 min because of: 1) overheating (reaching a safety temperature limit), and/or 2) overcharging (reaching a safety voltage limit).

Common charging methods for Lithium-Ion Batteries are disclosed in the Journal of Energy Storage 6 (2016) 125-141, as shown by Prior Art FIG. 1.

Except for the “voltage trajectory” method, all other LIB charging methods apply a constant current and/or a constant voltage in at least a step of the charging process.

There is no indication of cell cycle life nor of the cell temperature profile when these methods are used for 0-100% full charging of a LIB in less than 60 minutes (fast charging). There is no indication the methods stated apply to all battery chemistry.

With reference to Prior Art FIG. 2 the typical CCCV (Constant Current-Constant voltage) charging and Constant Current discharge profile, during the Constant Current step, the voltage increases from its initial value to a set voltage value (up to 4.4V). During the Constant Voltage step, up to 4.4V, the current drops to a set value (here 0.05 C or C/20).

During the rest time, current is nil, and voltage drops to reach an open-circuit voltage (OCV).

During the CC discharge, the current is fixed, and voltage drops to a limit (here 2.5V).

During the following rest time, current is nil, and voltage increases to a new OCV value.

With reference to Prior Art FIG. 3 that features Multistage constant current charge profile (MSCC), two charge currents have been applied successively to the cell, I1 and I2, (where in general I1>I2).

I1 is applied until voltage reaches a first value V1 Then I2 is applied until voltage reaches a value of V2 and so on.

Other currents Ij can be applied until a voltage Vj is reached, where V1>V2>V3> . . . Vj>Vj+1.

The MSCC charge process ends when either the target capacity is reached, or a voltage high limit is reached or a temperature limit is reached.

CCCV and MSCC are the most popular charging methods used in lithium-ion batteries today. CCCV and MSCC are simple and convenient methods if the full charging time is above 2 hours.

Both CCCV and MSCC are based on applying one or several charging constant current(s) (CC) up to preset voltage limit(s), then for CCCV by applying a constant voltage (CV).

Both CCCV and MSCC cannot realistically be used to charge a battery in less than one hour because of: 1) excess heat generation, 2) lithium metal plating on the anode side, which may create an internal short circuit and thermal runaway event, 3) the reduction of the battery life due to accelerated ageing.

Moreover, when used for charging battery cells connected in series, CCCV required cell balancing, as discussed, for example, in the paper “Implementation of a LiFePO4 battery charger for cell balancing application,” by Amin et al. / Journal of Mechatronics, Electrical Power, and Vehicular Technology 9 (2018) 81-88.

Cell balancing, which is required for high power applications implementing CCCV, has the disadvantages of slow balancing speed and thus time-consuming, complex switching structure, it and needs advanced control technique for switch operation, as shown in papers “Lithium-Ion Battery Pack Robust State of Charge Estimation, Cell Inconsistency, and Balancing: Review” by Mina Naguib et al, published in IEEE Access VOLUME 9, 2021, and “Review of Battery Cell Balancing Methodologies for Optimizing Battery Pack Performance in Electric Vehicles” by Zachary Bosire Omariba et al, published in IEEE Access VOLUME 7, 2019.

Fast charging (FC) protocols are reviewed in the paper “Lithium-ion battery fast charging: a review” published in eTransportation 1 (2019) 100011. Issues of fast-charging are identified for fast-charging with charging time<1 h: heat generation, lithium plating, materials degradation, limited charge uptake within tch (ΔSOC<100%), reduced cycle life, safety, and thermal runaway.

The paper in Journal of Energy Storage 29 (2020) 101342 recites CCCV limitations in fast charging and discloses that cycle life decreases when the Total Charge Time (TCT)=CCCT+CVCT decreases.

As recited in eTransportation 1 (2019) 100011, to date, no reliable onboard methods exist to detect the occurrence of crucial degradation phenomena such as lithium plating or mechanical cracking. Techniques for detecting lithium plating based on the characteristic voltage plateau are promising for online application, but fully reliable methods to distinguish lithium stripping from other plateau-inducing phenomena, or to detect plating where no plateau is observed, have not yet been reported.

Many studies on fast charging protocols have been of empirical or experimental nature, and therefore their performance has only been assessed for a limited range of cell chemistries, form factors, and operating conditions. Such results cannot be easily extended to other cell types or ambient temperatures, as supported by the often-conflicting findings reported by different authors.

A main objective of the present disclosure is to overcome these issues by proposing a new method for fast charging battery cells, which provides a significant decrease of charging times while preserving the integrity of the cells for a greater number of charge cycles.

Main symbols and definitions
i, I=Electric current intensity (A, mA . . . )
v, V=Cell voltage (in Volt, V)
Q_{ch}, q_{ch}=charge capacity (Ah, mAh . . . )
Q_{dis}, q_{dis}=discharge capacity (Ah, mAh . . . )
Qₙₒₘ=cell nominal capacity (Ah, mAh . . . )
C-rate=current intensity relative to the charge time in hour
   1 C-rate is the current intensity needed to achieve Qₙₒₘ in 1 h
   2 C-rate is the current intensity needed to achieve Qₙₒₘ in 0.5 h
   0.5 C-rate is the current intensity needed to achieve Qₙₒₘ in 2 h
SOC=state of charge relative to Qₙₒₘ (in %)
SOH=state of health is the actual full capacity of the cell relative to the initial Qₙₒₘ
SOS=state of safety estimated risk of thermal runaway
A=The time derivative of voltage

$$( A = \frac{\partial V}{\partial t} in V . {s}^{- 1} )$$

tₛ=step time (in s)
t_{ch}=charge time (in min)

### BRIEF SUMMARY

This goal is achieved with a method for fast charging a battery cell provided with charge/discharge terminals to which a charging voltage can be applied with a flowing charging current, the method comprising the steps of:
applying to terminals of the battery cell a plurality of constant voltage stages Vⱼ, where Vⱼ₊₁>Vⱼ, j=1, 2 . . . , k, each voltage stage comprising intermittent nⱼ voltage plateaus,
between two successive voltage plateaus within a voltage stage, letting the charging current going to rest (I=0 A) for a rest period Rⱼ^{p}, 1≤p≤nⱼ.
the fast-charging method proceeding until either one of the following conditions is reached:
   a pre-set charge capacity or state of charge (SOC) is reached,
   the cell temperature exceeds a pre-set limit value Tₗᵢₘ, and
   the cell voltage has exceeded a pre-set limit value Vₗᵢₘ.

A transition from a voltage stage Vⱼ to the following stage Vⱼ₊₁ is advantageously initiated when I_{j,p}^{fin}, p=nⱼ reaches a threshold value I_{j,nj}^{Thr}.

The fast-charging method of the present disclosure can further comprise a step for calculating the following stage Vⱼ₊₁ as =Vⱼ+ΔV(j), with ΔV(j) relating to the current change ΔI(j)=I_{j,p}ⁱⁿⁱ−I_{j,p}^{fin}, p=nⱼ.

The fast-charging method of the present disclosure can further comprise the steps of:
measuring the intensity (Io) of current in the battery cell during a voltage stage Vⱼ,
calculating an intensity variation (ΔI(j)) as ΔI(j)=Io−Iₗᵢₘᵢₜ, with Iₗᵢₘᵢₜ defined a predetermined limit current,
calculating a voltage variation (ΔV(j)) as ΔV(j)=Kₙ. ΔI(j), with Kₙ defined as an adjustable coefficient,
applying a new voltage stage Vⱼ₊₁=Vⱼ+ΔV(j) to the terminals of the battery cell.

The successive K-values Kₙ₋₁ to Kₙ can be determined by using a machine-learning technique, so as to maintain a sufficient charge of the battery cell.

The passage from a voltage plateau to the other is initiated either by detecting a current variation ΔI greater than a predetermined value, or by detecting a current smaller than a limit C-rate.

A limit C-rate that allows to move from a voltage plateau to another can be determined as C-Rate. (1+α), with α defined as a coefficient provided for compensating the rest time between two voltage plateaus.

The fast-charging method of any of the present disclosure can further comprise the steps of:
between two successive current rest times Rⱼ^{p-1} and Rⱼ^{p} within a voltage stage Vⱼ, and a pending voltage plateau, detecting the flowing pulse-like current dropping from an initial value I_{j,p}ⁱⁿⁱ reaches a final value I_{j,p}^{fin} where 1≤p≤nⱼ,
ending the pending voltage plateau, so that the flowing pulse-like current drops to zero for a rest time Rⱼ^{p}, with the voltage departing from Vⱼ.,
after the rest time Rⱼ^{p} is elapsed, applying back the voltage to Vⱼ.

The fast-charging method of the present disclosure can further comprise an initial step for determining an initial K-value and a charge step from inputs including charging instructions for C-rate, voltage and charge time.

The fast-charging method of the present disclosure can further comprise a step for detecting a C_{shift} threshold, leading to a step for determining a shift voltage, by applying a non-linear voltage equation and using K-value and ΔC-rate.

The fast-charging method of the present disclosure can be applied to a combination of battery cells arranged in series and/or un parallel.

According to another aspect of the present disclosure, there is proposed a system for fast-charging a battery cell, implementing the fast-charging method according to the present disclosure, the system comprising an electronic converter connected to a power source and designed for applying a charging voltage to the terminals of a battery cell, the electronic converter being controlled by a charging controller designed to process battery cell flowing current and cell voltage measurement data and charging instruction data, characterized in that the charging controller is further designed to control the electronic converter so as to:
apply to terminals of the battery cell a plurality of constant voltage stages Vⱼ, where Vⱼ₊₁>Vⱼ, j=1, 2 . . . , k, each voltage stage comprising intermittent nⱼ voltage plateaus,
between two successive voltage plateaus within a voltage stage, let the charging current going to rest (I=0 A) for a rest period Rⱼ^{p}, 1≤p≤nⱼ.

until either one of the following conditions is reached:
a pre-set charge capacity or state of charge (SOC) is reached,
the cell temperature exceeds a pre-set limit value Tₗᵢₘ, and
the cell voltage has exceeded a pre-set limit value Vₗᵢₘ.

The electronic converter can advantageously include a microcontroller with processing capabilities enabling (i) implementation of artificial methods and (ii) online storage and computation of VSIP data.

The present disclosure provides a Voltage Staged Intermittent Pulse battery charging method and charging systems (VSIP) consisting of:

The total full (100% ΔSOC) charging time is below 60 min and below 30 min.

Applying a plurality of constant voltage stages Vⱼ, where Vⱼ₊₁>Vⱼ, j=1, 2 . . . , k.

Each voltage stage consists of intermittent nⱼ voltage plateaus.

Between two successive voltage plateaus with a voltage stage the current goes to rest (I=0 A) for a period Rⱼ^{p}, 1≤p≤nⱼ.

During the current rest period Rⱼ^{p} the voltage departs from Vⱼ.

Between two successive current rest times Rⱼ^{p-1} and Rⱼ^{p} within a voltage stage Vⱼ the flowing pulse-like current drops from an initial value I_{j,p}ⁱⁿⁱ to a final value I_{j,p}^{fin} where 1≤p≤nⱼ.

When I_{j,p}^{fin} is reached, the current goes to rest (drops to zero) for a rest time Rⱼ^{p}.

After the rest time Rⱼ^{p} is elapsed the voltage goes back to Vⱼ.

The transition between voltage stage Vⱼ to the following stage Vⱼ₊₁ takes place when I_{j,p}^{fin}, p=nⱼ reaches a threshold value I_{j,nj}^{Thr}.

The voltage step ΔV(j)=Vⱼ₊₁−Vⱼ relates to the current change ΔI(j)=I_{j,p}ⁱⁿⁱ−I_{j,p}^{fin}, p=nⱼ.

The VSIP charge process proceeds until either one of the following conditions is reached: 1) a pre-set charge capacity or state of charge (SOC) is reached, 2) the cell temperature exceeds a pre-set limit value Tₗᵢₘ, and 3) the cell voltage has exceeded a pre-set limit value Vₗᵢₘ.

The main characteristics of the VSIP method are:

VSIP fully charges a battery (ΔSOC=100%) in a time lower than 30 min.

The charging time is even lower if ΔSOC<100% (partial charge such as, for example, from 20 to 100%, ΔSOC=80%).

The cell voltage during VSIP may exceed 4.5V in LIB, 2V in alkaline cells and 3V in lead acid batteries.

During VSIP none of the voltage and current is constant for a period higher than 3 min.

The temperature difference between the cell temperature Tcell and the ambient temperature Tamb remains below 25° C. (Tcell−Tamb<35° C.) during VSIP.

The VSIP operating parameters are adjustable according to the cell chemistry, SOC, SOH and SOS.

VSIP parameters adjustment can be performed using artificial intelligence (AI, such as machine learning, deep learning . . . ).

VSIP applies to individual battery cells as well as to cells arranged in series and in parallel (battery modules, battery packs, power wall, . . . ).

VSIP applies to a variety of battery cell chemistries including and not limited to LIB, solid-state lithium batteries, sodium-based anode cells, zinc-based anode cells, alkaline, acid, and high temperature cells (i.e., molten metal cells) . . . .

Two successive VSIP current and voltage profiles can be different from each other.

The advantages provided by the fast-charging VSIP method according to the present disclosure are:
VSIP is a universal charging technology that applies to all types of rechargeable batteries, including lead acid, alkaline, lithium ion, lithium polymer and solid-state lithium cells and for any application, including but not limited to ME, EM and ESS.
VSIP fully charges batteries (from 0 to 100% SOC) below 60 min and below 30 minutes, while keeping the cell temperature below 50° C. (safety) and providing long life span.
VSIP can apply for quality control (QC) of batteries for specific applications (stress test).
Because VSIP is an adapted charging method it extends the life span of batteries under any operation conditions (power profile, temperature, . . . ).
VSIP increases the energy density of battery cells versus their rated energy density.
Although VSIP is designed for fast charging it also applies to longer charging times tch>60 min.

A fast charge cycle performance index Φ is also provided as:

$$Φ = {\sum }_{i = 1}^{n} \frac{{Q}_{d i s c h}^{i} / {Q}_{n o m}}{{t}_{i}}$$

with
Φ=normalized cycle performance index
i=cycle number
tᵢ=charge time @ i^{th} cycle (hr)
Q_{disch}ⁱ=discharge capacity @ i^{th} cycle (Ah)
Qₙₒₘ=nominal capacity (Ah)
n=cycle number when Q_{disch}ⁱ/Qₙₒₘ falls below ˜80%

A new technology for safely fast charging LIB based on Voltage Step Intermittent Pulse (VSIP) has been demonstrated.

VSIP is an adapted charging technology with adjustable parameters either manually or using artificial intelligence methods and techniques.

VSIP 100% SOC charge below 20 min is possible while keeping low temperatures (<45° C.) and long cycle life (>1300 #).

Partial charge (ΔSOC<100%) can be performed below 10 min.

Voltages above 4.5V can be safely reached under VSIP charge.

There is no sign of lithium plating during VSIP charge.

Over 1000 charge-discharge cycles can be achieved with ΔSOC≤100% with VSIP charge.

VSIP can be used for: 1) cell's quality control. 2) single cells and for cells arranged in series and in parallel (battery module and battery pack), 3) storage capacity enhancement,

Fast charging performance index can be used as a metrics to compare fast charge protocols.

Furthermore, with the NLV based fast-charge method according to the present disclosure, it is no longer necessary to provide cell balancing for the charging of battery cells connected in series, since it is the charging voltage that is now controlled. Thus, the fast-charging method of the present disclosure provides intrinsic balancing between the battery cells.

### BRIEF DESCRIPTION OF THE DRAWINGS

Figures showing Prior Art:

FIG. 1 is a schematic description of prior art charging methods;

FIG. 2 shows Typical CCCV charging and CC discharge profile;

FIG. 3 shows Multistage constant current charge profile (MSCC);

FIG. 4 and FIG. 5 show The CCCV limitations in fast charging;

Figures showing the present disclosure:

FIG. 6 shows typical voltage and current profiles during VSIP charge and CC discharge cycles;

FIG. 7 shows typical voltage and current profiles during VSIP charge and CC discharge (here full charge time is 26 min);

FIG. 8 shows typical voltage and current profiles during VSIP charge;

FIG. 9 shows typical voltage profile during VSIP with a plurality of voltage stages Vⱼ (here total charge time is about 35 min);

FIG. 10 shows detailed voltage and current profiles during VSIP charge showing voltage and current intermittency.

FIG. 11 shows detailed voltage and current profiles during VSIP charge showing rest time;

FIG. 12 shows Voltage and current profiles during rest time showing a voltage drop;

FIG. 13 shows current profile at stage j;

FIG. 14 shows current profile at sub-step j,p;

FIG. 15 shows Typical ΔV(j)=Vⱼ₊₁−Vⱼ vs. Time profile during VSIP charging in ˜17 min over many cycles;

FIG. 16 shows voltage and gained capacity during VSIP charge in 26 mn;

FIG. 17 shows discharge profile of 12 Ah cell after VSIP charge in 26 mn;

FIG. 18 shows linear voltammetry vs VSIP;

FIG. 19 shows two successive VSIP charge profiles can be different from each other;

FIG. 20 shows VSIP charge voltage and current profiles (60 min);

FIG. 21 shows VSIP charge voltage and current profiles (45 min);

FIG. 22 shows VSIP charge voltage and current profiles (30 min);

FIG. 23 shows VSIP charge voltage and current profiles (20 min);

FIG. 24 shows 80% partial charge with VSIP in ˜ 16 min;

FIG. 25 shows Temperature profile during VSIP charge in 30 min: Stress test for LIB quality control (QC);

FIG. 26 shows Temperature profile during VPC in 20 min of a good quality cell;

FIG. 27 shows VSIP enhances cell's capacity;

FIGS. 28 and 29 show VSIP applies to multi-cell systems in parallel;

FIGS. 30 and 31 show VSIP applies to multi-cell systems in series;

FIG. 32 shows a Cycle performance index;

FIG. 33 is a VSIP flow diagram, with a Bayesian optimization;

FIG. 34 is a schematic view of a fast-charging VSIP system;

FIG. 35 shows 4 cells-in-series voltage profiles measured during a NLV charge in about 30 min.

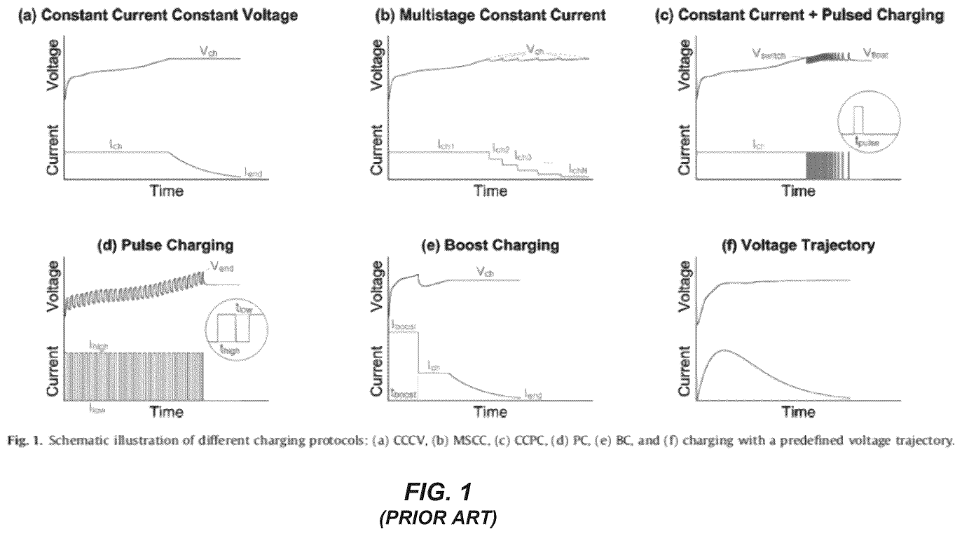

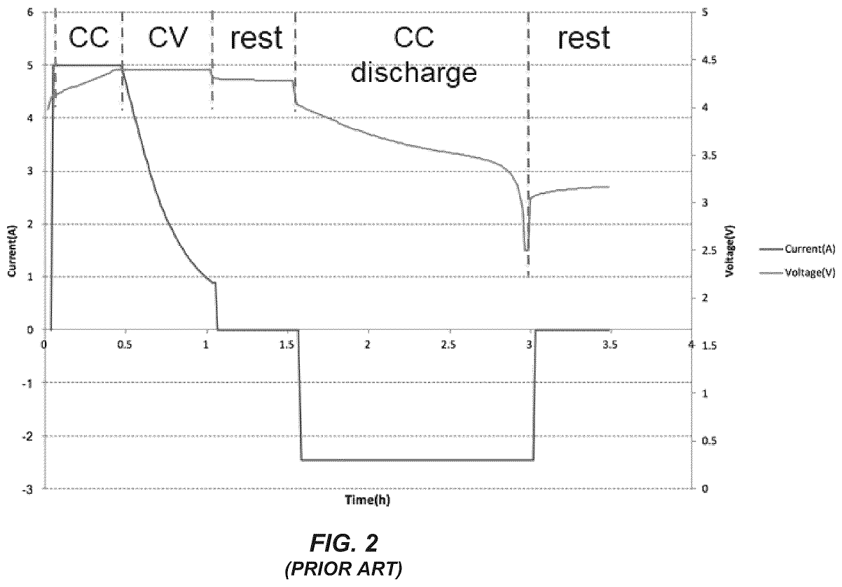

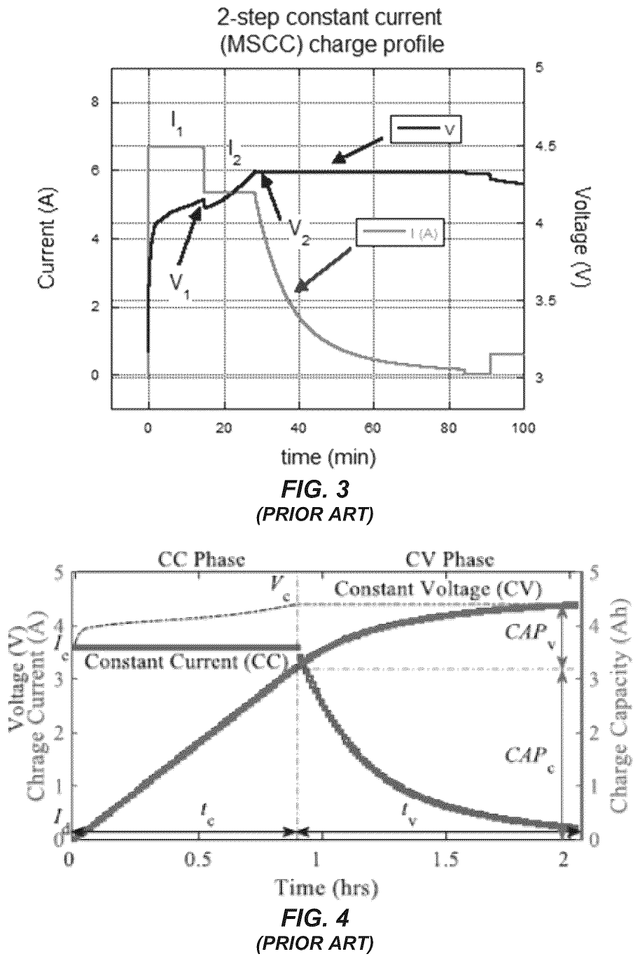

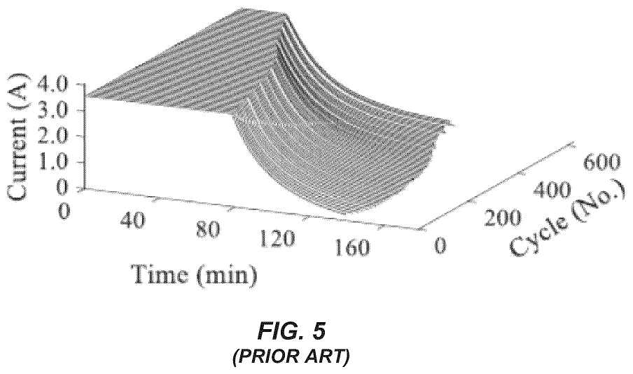

### DETAILED DESCRIPTION

For programming a controller implementing the fast-charging method according to the present disclosure, with an artificial intelligence (AI)-based approach, a list of duty criteria is proposed:
Fixing the charging time t_{ch}
Reaching the target capacity in t_{ch}
Keeping temperature under control (<60° C.)
Achieving the target cycle number
Ensuring battery safety
Enhancing capacity

The variables in the fast-charging method according to the present disclosure are:
The VSIP governing equation

A=ΔV/Δt=f(i,V,Δi/Δt,T,SOC,SOH)
The charge current limits
The current trigger for next voltage step
The rest time
The temperature limit
The voltage limit
The target capacity limit

A Bayesian optimization is used to adjust the Non Linear Voltammetry (NLV) variables.

The NLV variables are adjusted at each cycle to meet the criteria:

$$A = \frac{ΔV}{Δ t} = f ( i , V , \frac{Δ i}{Δ t} , T , SOC , SOH )$$

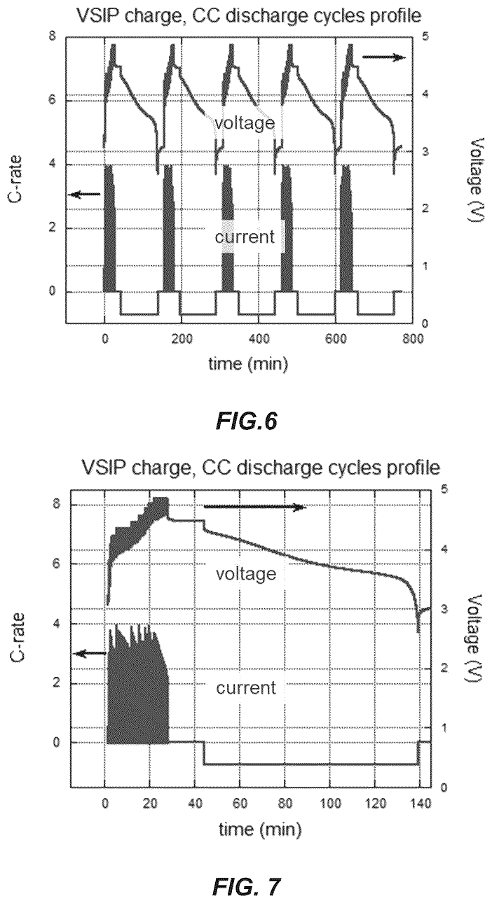

With reference to FIGS. 6 and 7, in a first embodiment, the fast charging (VSIP) method according to the present disclosure is implemented during charge sequences within VSIP charge, CC discharge cycles. In these profiles, the C-rate is representative of the current in the battery cell.

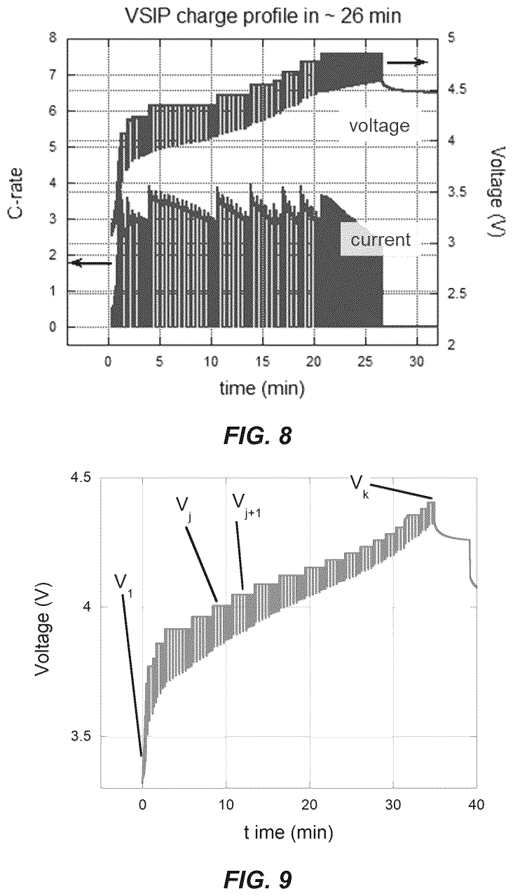

As shown in FIGS. 8 and 9, a VSIP charge sequence, which has a duration of about 26 min, includes a number of increasing voltage stages, each voltage stage V₁, . . . , Vⱼ, Vⱼ₊₁, . . . Vₖ including constant voltage plateau.

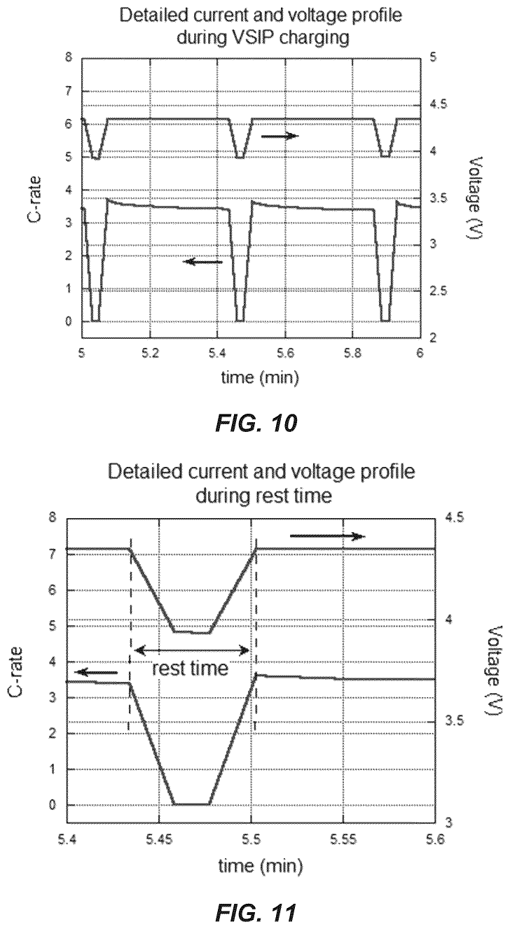

A shown in FIGS. 10 and 11, during each voltage plateau in a VSIP charging sequence, the voltage profile is constant and decreases to a low constant voltage between two successive plateaus, while the C-rate profile includes a decrease during each plateau and decreases to zero during the rest period between two plateaus.

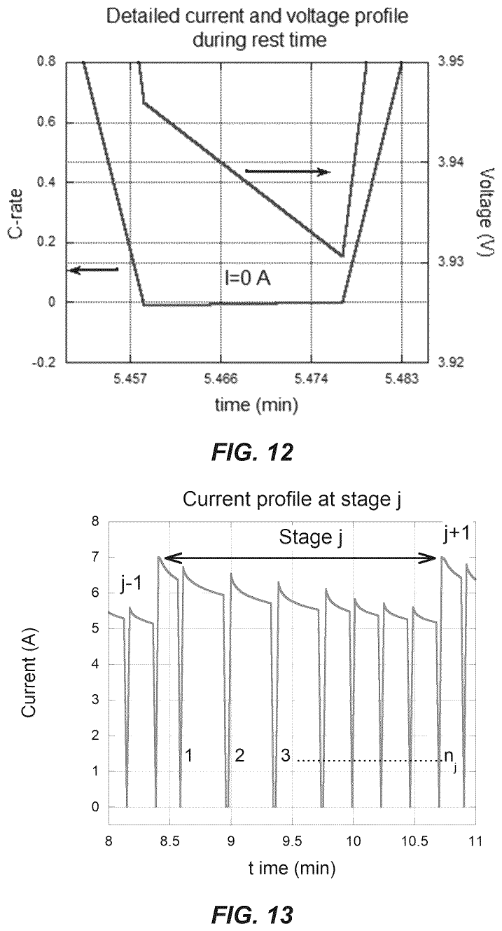

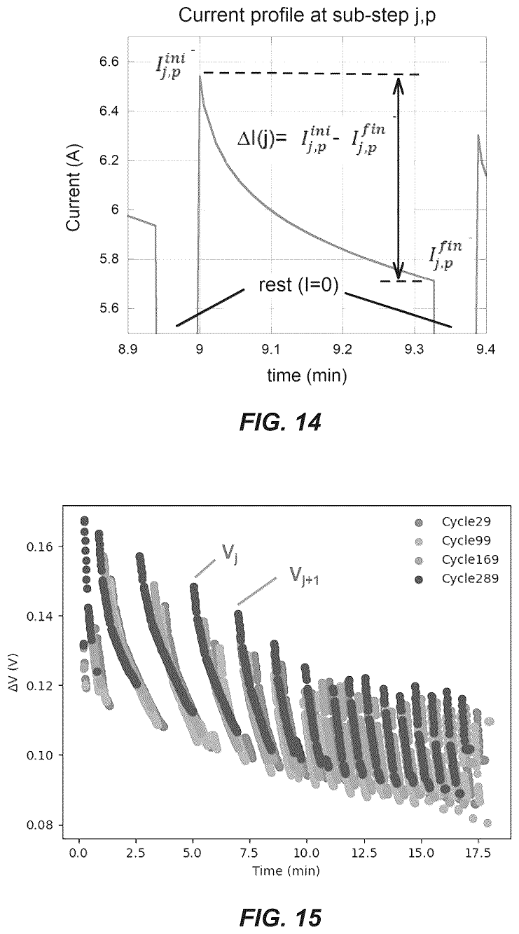

During a rest time, as illustrated by FIG. 12 showing detailed current and voltage profile, the voltage can be controlled so that

$$\frac{Δ V}{Δ t}$$

has a constant negative value calculated as above described.

As shown in FIG. 13, a voltage stage j includes current impulsions 1, 2, 3, . . . nⱼ in response to voltage plateaus applied to the terminal of a battery cell.

During a voltage plateau Vⱼ, the current at sub-step j,p decreases from I_{j,p}ⁱⁿⁱ to I_{j,p}^{fin}, as shown in FIG. 15.

For a large number of charging cycles operated with the fast-charging method according to the present disclosure, the voltage variations ΔV experienced between the successive voltage plateau within successive voltage stages Vⱼ, Vⱼ₊₁. globally decrease with time, as shown in FIG. 15.

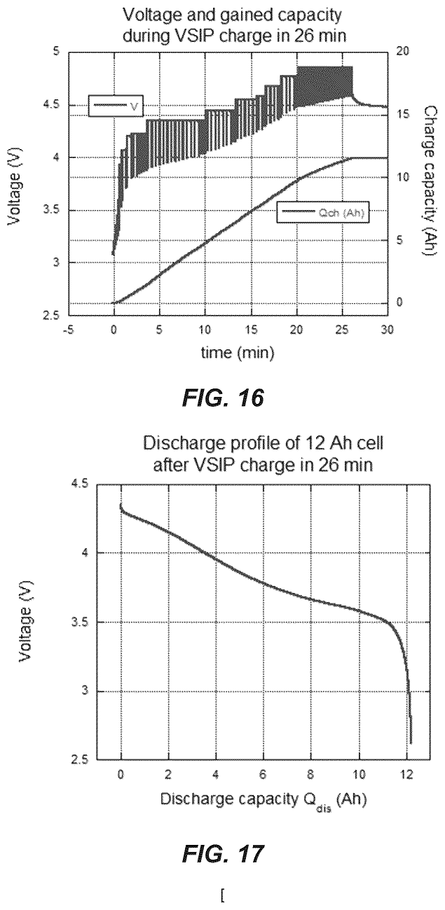

During a voltage charge VSIP sequence lasting 26 min full charge time as shown in FIG. 16, the charge capacity Q_{ch} continuously increases while the corresponding voltage profile includes successive voltage stages each comprising voltage plateau with rest times. As shown in FIG. 17, during a following discharge sequence, the discharge capacity Q_{dis} decreases with the voltage applied to the terminals of the battery cell.

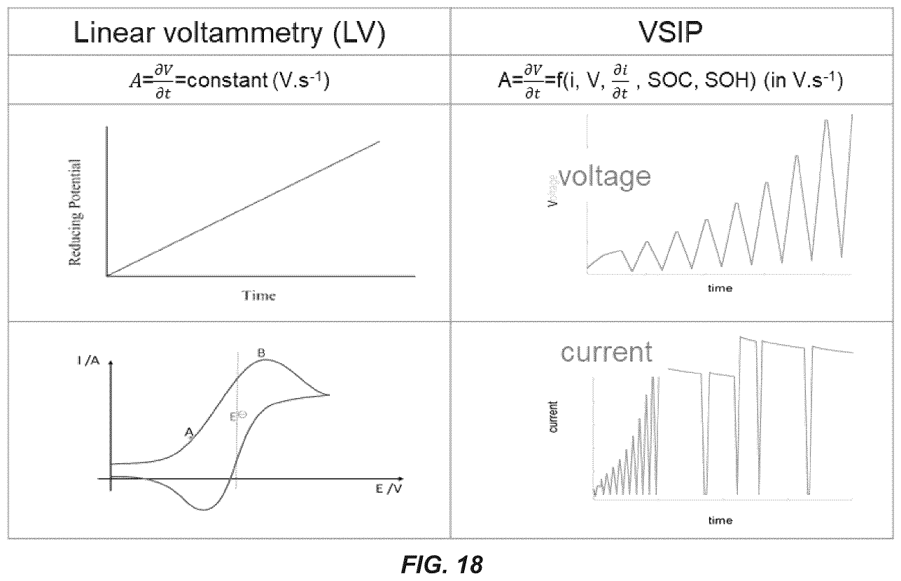

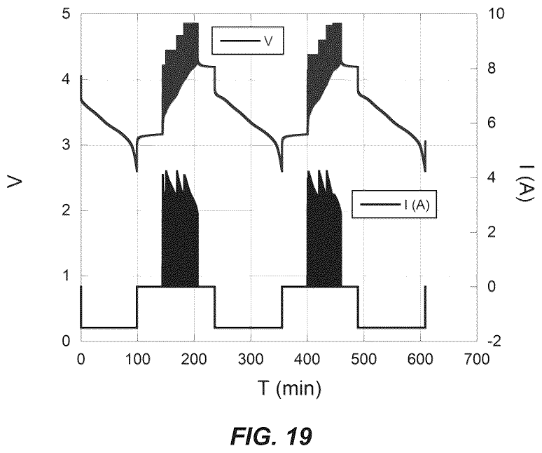

The VSIP fast charging method according to the present disclosure clearly differs from a conventional Linear Voltammetry (LV) method, with respective distinct voltage and current profiles shown in FIG. 18. The respective current and voltage profiles can differ from a charge/discharge VSIP cycle to another, as shown in FIG. 19.

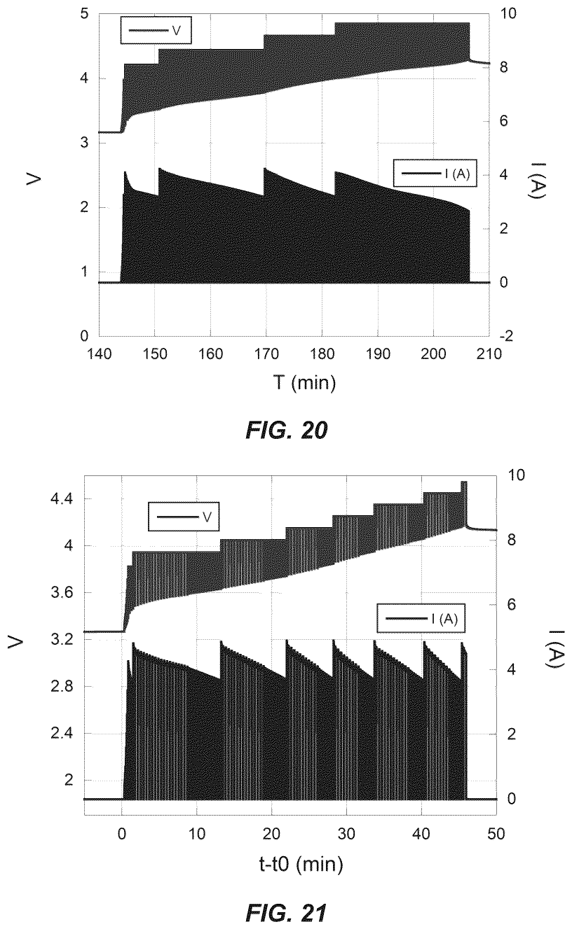

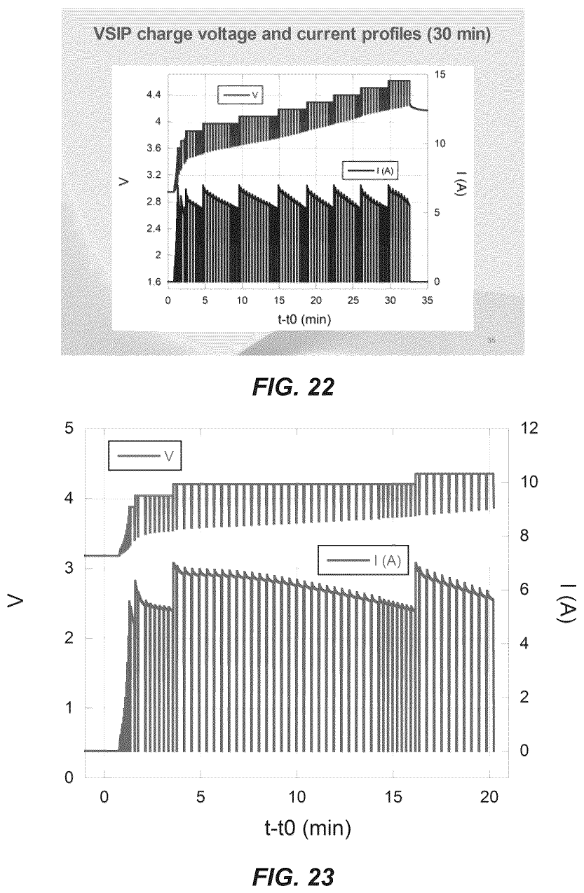

The variability of voltage and current profiles is also observed when the charge time is modified, for example, from 60 min, 45 min, 30 min to 20 min, with reference to respective FIGS. 20, 21, 22 and 23. For a 60 min charge time, the charge sequence includes 4 voltage stages (FIG. 20), and for a 45 min charge time the charge sequence includes 8 voltage stages (FIG. 21). For a 30 min charge time, the charge sequence includes 10 voltage stages (FIG. 22) and for a 20 min charge time, the charge sequence includes 4 voltage stages (FIG. 23).

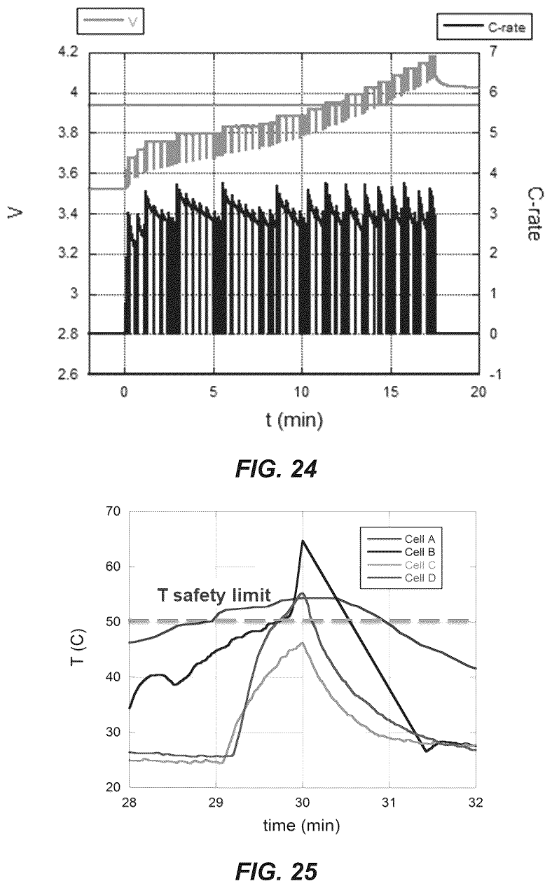

As shown in FIG. 24, the VSIP charging method according to the present disclosure allows an 80% partial charge of a Lithium-Ion battery cell in about 16 min.

With reference to FIG. 25, during a VSIP charge in 30 min, cells A, B and D had temperature raising above the safety limit of 50° C. These battery cells didn't pass the VSIP stress test. Only cell C passed the stress test. It means that all LIB cells can't be fast charged.

Thus, the VSIP charging method according to the present disclosure can also be used as stress quality control (QC) test before using a cell in a system for fast charging.

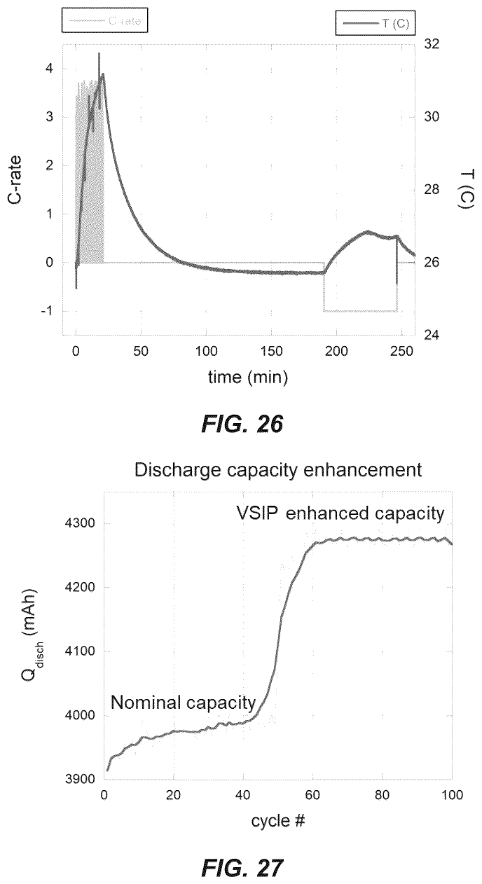

With reference to FIG. 26, during a charge sequence of an excellent quality LIB cell, the full charge is reached in about 20 min and the temperature of the cell does not exceed 32° C.

With reference to FIG. 27, by adjusting the VSIP parameters such as the upper voltage limit, the step time, ΔV and ΔI/Δt for the voltage step transition, the discharge capacity can be improved without compromising safety and life span.

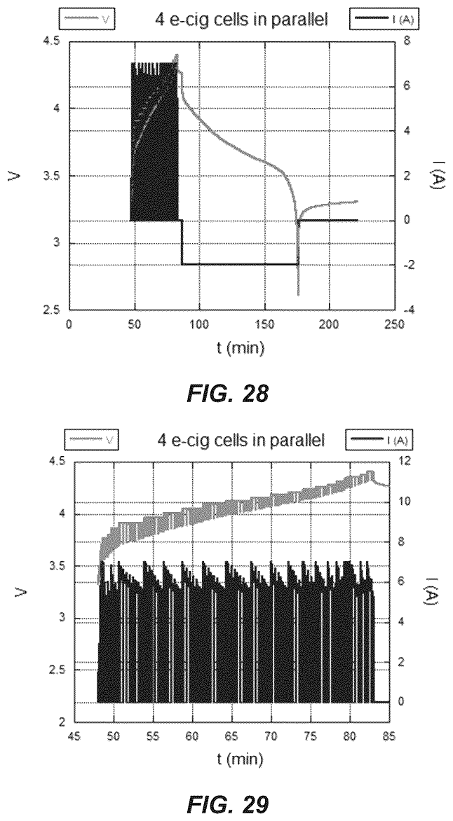

The VSIP charging method according to the present disclosure can be implemented for charging 4 LIB cells assembled in parallel in about 35 min, as shown in FIG. 28 with a CC discharge and in FIG. 29, which is a detailed view of the voltage and current profiles during the VSIP charge sequence of FIG. 28,

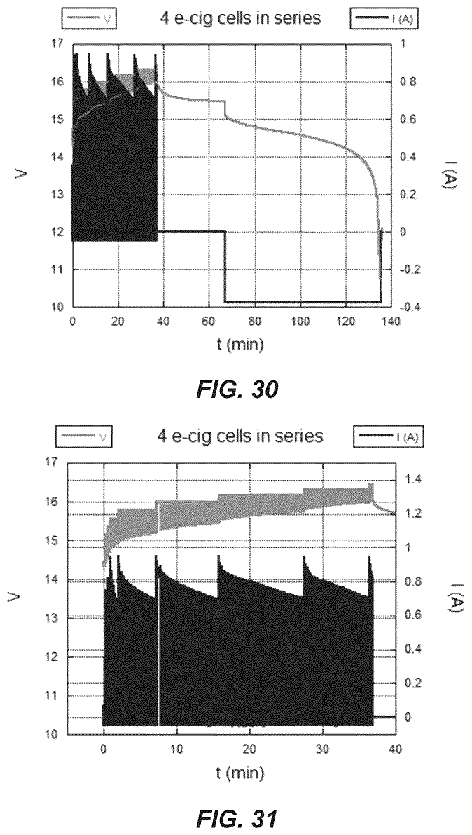

With reference to FIGS. 30, 31 and 35, the VSIP charging method according to the present disclosure can also be applied for charging 4 e-cig cells in series, in about 35 min.

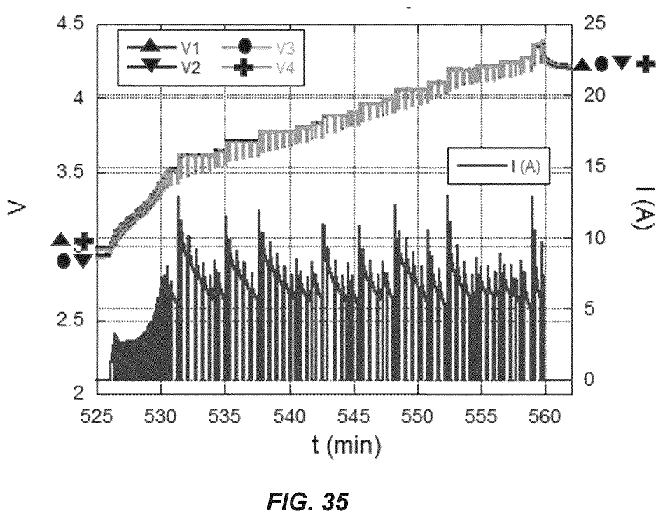

As shown in FIG. 35, the profiles of the voltages V1, V2, V3 and V4, corresponding to 4 cells connected in series and measured during a NLV charge, are very close to each other, which avoids cell balancing.

Note that in this configuration, the VSIP charging method is particularly advantageous, compared to CCCV, as it no longer requires a time-consuming and energy-using active cell balancing.

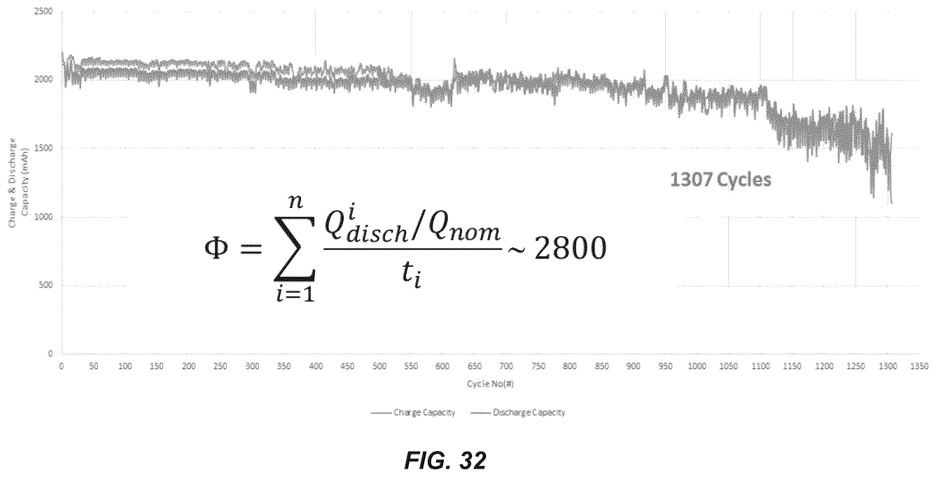

As shown in FIG. 32, the charge and discharge capacity varies as a function of the number of cycles, A fast charge cycle performance index Φ can be calculated as:

$$Φ = {\sum }_{i = 1}^{n} \frac{{Q}_{d i s c h}^{i} / {Q}_{n o m}}{{t}_{i}}$$

with
Φ=normalized cycle performance index
i=cycle number
tᵢ=charge time @ i^{th} cycle (hr)
Q_{disch}ⁱ=discharge capacity @ i^{th} cycle (Ah)
Qₙₒₘ=nominal capacity (Ah)

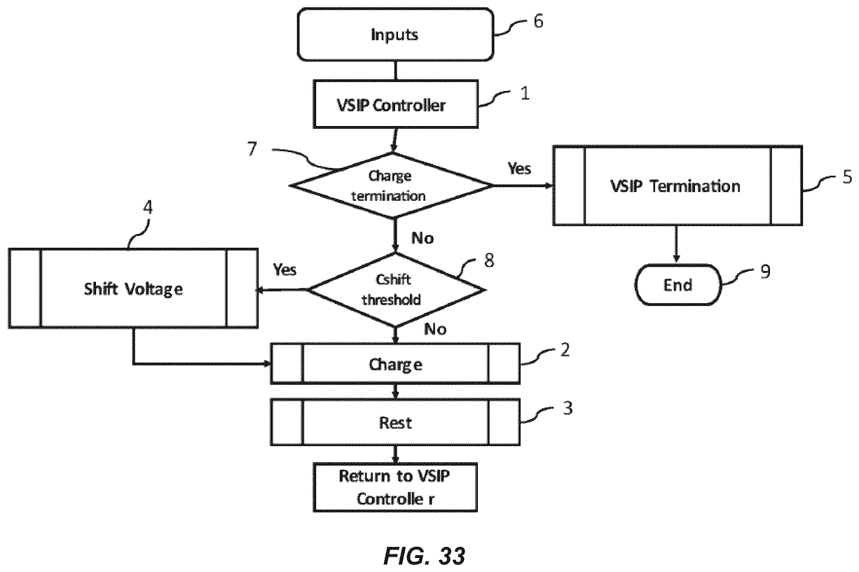

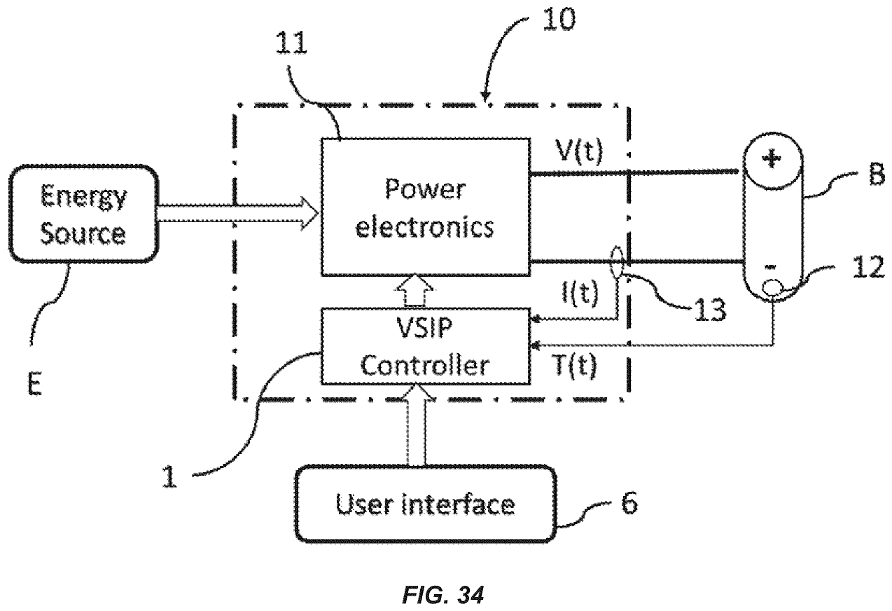

With reference to FIGS. 33 and 34, an example of a VSIP fast-charging system, along with the implemented VSIP charging method, is now described. This VSIP controller 1 includes a power electronics converter 11 designed for processing electric energy provided by an external energy source E and supplying a variable voltage V(t) to a battery cell B to be charged. Note that this battery cell B can be replaced by a system of battery cells connected in series and/or in parallel.

The VSIP controller 1 further includes a VSIP controller 1 designed for receiving and processing:
measurement data provided by a current sensor 13 placed in the current circuit between the power electronics converter 11 and the battery cell B, and by a temperature sensor 12 placed on or in the battery cell B,
instruction data collected from a user interface, including inputs such as an expected C-Rate, a charge voltage instruction and a charge time instruction.

The VSIP controller 1 is further designed to control power electronics components within the converter 10 so as to generate a charge voltage profile according to the VSIP method until at least of one the termination criteria for ending 9 the charging process are met.

These VSIP termination criteria 5 include:
minimum C-Rate cut-off,
safety voltage exceeded,
charge capacity reached,
over temperature.

From inputs “C-Rate,” “Voltage” and “elapsed charge Time,” which can be entered as instructions 6 by a user, the VSIP controller 1 first determines an initial K value and a charge step.

Provided that no charge termination criterion is met and a predetermined threshold for C-Rate is not reached, the VSIP controller 1 launches a charge sequence 2 by applying voltage for a charge step duration and C-Rate—which is an image of the current flowing into the battery cell—is measured.

When current reaches a pre-set C-rate value, the VSIP controller 1 commutes to a rest period 3 during which no voltage is applied to the battery cell. The duration of this rest period depends on the measured C-Rate before current decreasing.

If the C shift reaches the determined threshold 8, the VSIP controller 1 calculates a shift voltage 4 required to maintain a sufficient charge of the battery cell. This calculation is based on the NLV equation using K-value and ΔC-rate. The calculated shift voltage is then applied for applying a new voltage stage to the battery cell.

Of course, the present disclosure is not limited to the above-described examples and other embodiments can be considered without departing from the scope of the present disclosure.

1. A method for fast-charging a battery cell provided with charge/discharge terminals to which a charging voltage can be applied with a flowing pulse-like charging current, the method comprising the steps of:
applying to terminals of the battery cell a plurality of constant voltage stages Vⱼ, where Vⱼ+>Vⱼ, j=1, 2 . . . , k, each voltage stage comprising intermittent nⱼ voltage plateaus,
between two successive voltage plateaus within a voltage stage, letting the charging current go to zero for a rest period Rⱼ^{p}, 1≤p≤nⱼ.
the fast-charging method proceeding until any one of the following conditions is reached:
a pre-set charge capacity or state of charge is reached,
the battery cell temperature exceeds a pre-set limit value Tₗᵢₘ, or
the battery cell voltage exceeds a pre-set limit value Vₗᵢₘ.

2. The fast-charging method of claim 1, wherein a transition from a voltage stage Vⱼ to the following stage Vⱼ₊₁ is initiated when I_{j,p}^{fin}, p=nⱼ reaches a threshold value I_{j,nj}^{Thr}.

3. The fast-charging method of claim 2, further comprising a step for calculating the following stage Vⱼ₊₁ as =Vⱼ+ΔV(j), with ΔV(j) relating to the current change ΔI(j)=I_{j,p}ⁱⁿⁱ−I_{j,p}^{fin}, p=nⱼ.

4. The fast-charging method of claim 3, further comprising the steps of:
measuring an intensity of current in the battery cell during a voltage stage Vⱼ,
calculating an intensity variation (ΔI(j)) as ΔI(j)=Io−Iₗᵢₘᵢₜ, with Iₗᵢₘᵢₜ defined by a predetermined limit current,
calculating a voltage variation (ΔV(j)) as ΔV(j)=Kₙ. ΔI(j), with Kₙ defined as an adjustable coefficient,
applying a new voltage stage Vⱼ₊₁=Vⱼ+ΔV(j) to the terminals of the battery cell.

5. The fast-charging method of claim 4, wherein the successive K-values Kₙ₋₁ Kₙ are determined by using a machine-learning technique, so as to maintain a sufficient charge of the battery cell.

6. The fast-charging method of claim 1, further comprising the steps of:
between two successive current rest times Rⱼ^{p-1} and Rⱼ^{p} within a voltage stage Vⱼ, and a pending voltage plateau, detecting the flowing pulse-like charging current dropping from an initial value I_{j,p}ⁱⁿⁱ to a final value I_{j,p}^{fin} where 1≤p≤nⱼ,
ending the pending voltage plateau, so that the flowing pulse-like charging current drops to zero for a rest time Rⱼ^{p}, with the voltage departing from Vⱼ,
after the rest time Rⱼ^{p} has elapsed, applying back the voltage to Vⱼ.

7. The fast-charging method of claim 1, further comprising an initial step for determining an initial K-value and a charge step from inputs including charging instructions for C-rate, voltage and charge time.

8. The fast-charging method of claim 7, further comprising a step for detecting a C_{shift} threshold, leading to a step for determining a shift voltage, by applying a non-linear voltage equation and using K-value and ΔC-rate.

9. The fast-charging method of claim 1, wherein the method is applied to a combination of battery cells arranged in series and/or in parallel.

10. The fast-charging method of claim 9, wherein the method is implemented to charge a plurality of battery cells connected in series, and wherein the method comprises intrinsic balancing between the battery cells.

11. A system for fast-charging a battery cell, implementing the fast-charging method according to claim 1, the system comprising an electronic converter connected to an energy source and designed for applying a charging voltage to the terminals of the battery cell, the electronic converter being controlled by a charging controller designed to process measurements of battery cell flowing current and temperature and charging instruction data, characterized in that the charging controller is further designed to control the electronic converter so as to:
apply to terminals of the battery cell a plurality of constant voltage stages Vⱼ, where Vⱼ₊₁>Vⱼ, j=1, 2 . . . , k, each voltage stage comprising intermittent nⱼ voltage plateaus,
between two successive voltage plateaus within a voltage stage, let the charging current going to rest for a rest period Rⱼ^{p}, 1≤p≤nⱼ.
until either one of the following conditions is reached:
a pre-set charge capacity or state of charge is reached,
the battery cell temperature exceeds a pre-set limit value Tₗᵢₘ, and
the battery cell voltage has exceeded a pre-set limit value Vₗᵢₘ.

12. The system of claim 11, wherein the electronic converter includes a microcontroller with processing capabilities enabling implementation of artificial intelligence methods and online storage and computation of VSIP data.

13. The system of claim 11, wherein the system is configured to charge a system of battery cells connected in series, wherein the charging controller is further designed to provide intrinsic balancing between the battery cells.
